(19) United States
(12) Patent Application Publication
(10) Pub. No.: US 2006/0061549 A1
(43) Pub. Date: Mar. 23, 2006

(54) [MULTI-DRECTIONAL CURSOR CONTROL DEVICE]

(75) Inventor: Kuan-Hung Chen, TAIPEI (TW)

Correspondence Address: PATEN WIRELESS TECHNOLOGY INC., 2F-4, NO. 148, SEC. 4, CHUNG HSIAO EAST ROAD, TAIPEI, TW

(73) Assignee: PATEN WIRELESS TECHNOLOGY INC., Nei-Hu District, Taipei City. (TW)

(21) Appl. No.: 11/162,461

(22) Filed: Sep. 11, 2005

(30) Foreign Application Priority Data
Sep. 17, 2004 (TW) 093214919

(51) Int. Cl. G09G 5/08

(52) U.S. Cl. 345/157

(57) ABSTRACT

A multi-directional cursor control device includes a housing having an accommodating chamber and an opening, a cursor control unit mounted inside the accommodating chamber, and a movable operating member, which is movably supported on the cursor control unit inside the accommodating chamber and has an arched operating top wall protruding over the opening of the housing for operation by the user to drive the cursor control unit to produce an output signal indicative of the direction and amount of movement of the operating member.

This application claims the priority benefit of Taiwan patent application number 093214919 filed on Sep. 17, 2004.

### BACKGROUND OF THE INVENTION

1. Field of the Invention

The present invention relates cursor control device and more particularly, to a multi-directional cursor control device, which uses a dome-like movable operating member for moving by the user to drive a cursor control unit to produce an output signal that moves the cursor on the display screen subject to the direction and amount of movement of the operating member.

2. Description of the Related Art

Following fast development of high technology, a variety of sophisticated electronic apparatus has been continuously developed and has appeared on the market. In recent years, many mobile electronic apparatus such as mobile computer, cellular telephone, PDA, remote controller for model toy vehicle, palmtop game machine, and etc. provide a display screen and a simple operation interface for controlling the positioning of a cursor on the display screen. An operation interface for this purpose may have a crossed, disk-like, hexagonal or octagonal switch key for operation by the user, a circuit board, which is provided below the switch key and has a plurality of switching (normally there are five switching contacts respectively arranged at the center, top, bottom left and right sides), and a plurality of spring strips respectively arranged above the switching contacts of the circuit board below the switching key. When the user pressed the switch key to force one metal spring strip against the respective switching contact, the circuit board is driven to produce an output signal that moves the cursor on the display screen in the corresponding direction. When changing the direction, the user must press the switch key to force the respective metal spring strip against the respective switching contact subject to the desired direction. Thus, the user may have to frequently press different parts of the switch key and then release the pressure from the switch key when operating the electronic apparatus, and the parts of this operation interface may wear quickly with use.

An operation interface for the aforesaid purpose may be made in the form of a joystick. A joystick type operation interface comprises a pivoted stick, an actuating unit movable with the pivoted stick, a press member, a plurality of metal spring strips, and a circuit board that has a plurality of switching contacts corresponding to the metal spring strips. During operation, the user can turn the pivoted stick to move the actuating unit in all directions, and can also force the press member to drive one of the metal spring strips, causing the driven metal spring strip to trigger the respective switching contact at the circuit board, thereby positioning the cursor on the display screen as desired. This design of operation interface is convenient to operate. However, because the pivoted stick requires much vertical installation space, this design of operation interface is not suitable for use in an electronic apparatus that has light, thin, short and small characteristics.

FIG. 9 shows a cursor control device according to the prior art. According to this design, the cursor control device comprises a housing A, which has a spherical inside guide surface A1, a semispherical shell C, which has a vertical center through hole C1, a top retaining portion C2 spaced around the vertical center through hole C1 and a bottom driving portion C4, an operating key B, which comprises a key shaft B1 inserted into the vertical center through hole C1 of the semispherical shell C and a retaining portion B2 engaged with the retaining portion C2 of the shell C, a first spring member B3, which supports the operating key B above the semispherical shell C, a printed circuit board E, which is provided at the bottom side of the semispherical shell C and has a plurality of switching contacts E1, a rubber pad D, which is covered on the printed circuit board E and has a plurality of switches D1 suspending above the switching contacts E1 of the printed circuit board E below the bottom driving portion C4 of the shell C, and a second spring member C3, which supports the semispherical shell C above the rubber pad D. When the user bias the operating key B, the semispherical shell C is moved with the operating key B to force the bottom driving portion C4 against the switches D1, causing the switches D1 to trigger the respective switching contacts E1, and therefore the printed circuit board E is driven to produce an output signal indicative of the direction and amount of movement of the operating key B. This design of cursor control device is functional; however it still has drawbacks as follows.

1. Because two spring members B3 and C3 are used and disposed at different elevations, the user must apply much pressure to the operating key B to force the bottom driving portion C4 of the semispherical shell C against the switches D1 and the respective switching contacts E1 at the printed circuit board E. During operation, the key shaft B1 may break accidentally. Further, an elastic fatigue may occur after a long use of the spring members B3 and C3, resulting in malfunctioning of the switching structure.

2. The retaining portion B2 of the operating key B may break easily when the user biases the operating key B in case the spring members B3 start to wear.

3. Because this design of cursor control device is comprised of a big number of component parts, the assembly process is complicated. A significant size error of the component parts may result in an alignment error between the two spring members B3 and C3, or an engagement failure between the retaining portions B2 and C2.

Therefore, it is desirable to provide a cursor control device that eliminates the aforesaid drawbacks.

### SUMMARY OF THE INVENTION

The present invention has been accomplished under the circumstances in view. It is the main object of the present invention to provide a multi-directional cursor control device, which has a simple structure that is easy and inexpensive to manufacture. It is another object of the present invention to provide a multi-directional cursor control device, which accurately controls the movement of the cursor on the display screen. To achieve these and other objects of the present invention, the multi-directional cursor control device comprises a housing, a cursor control unit mounted inside the housing, and an operating member for moving by the user to drive the cursor control unit to produce an output signal indicative of the direction and amount of movement of the operating member, wherein the housing comprises an accommodating chamber that accommodates the cursor control unit and the operating member, and an opening in the top wall thereof in communication with the accommodating chamber; the operating member has an arched operating top wall protruding over the opening of the housing for operation by the user. Further, the operating member has a top center recess at the top center of the arched operating top wall for operation by the user with one single finger.

### BRIEF DESCRIPTION OF THE DRAWINGS

FIG. 1 is an exploded view of a multi-directional cursor control device according to the present invention.

FIG. 2 is an elevational assembly view of the multi-directional cursor control device according to the present invention.

FIG. 3 is a side view in section of the multi-directional cursor control device according to the present invention.

FIG. 4 is a schematic sectional view of the present invention, showing the operation of the multi-directional cursor control device (I).

FIG. 5 is a schematic sectional view of the present invention, showing the operation of the multi-directional cursor control device (II).

FIG. 6 is a sectional side view of an alternate form of the multi-directional cursor control device according to the present invention.

FIG. 7 is a schematic drawing showing another operation example of the present invention.

FIG. 8 is a sectional side view of another alternate form of the present invention.

FIG. 9 is a side view in section of a cursor control device according to the prior art.

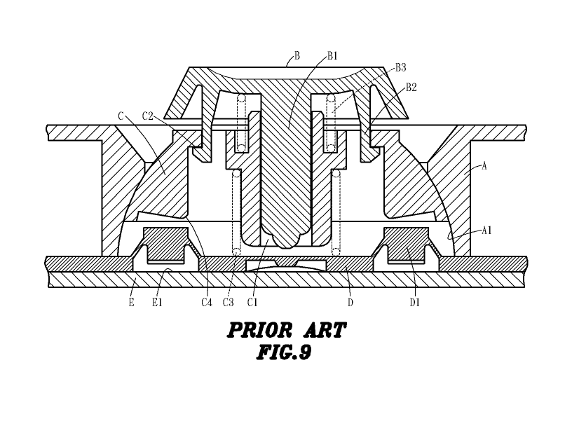

### DETAILED DESCRIPTION OF THE PREFERRED EMBODIMENT

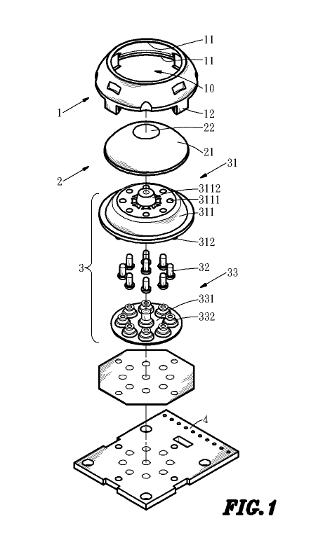

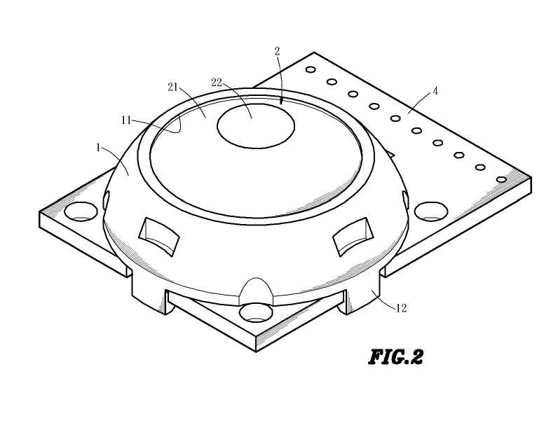

Referring to FIGS. 1-3, a multi-directional cursor control device in accordance with the present invention is shown comprising a housing 1, a movable operating member 2, and a cursor control unit 3.

The housing 1 is a hollow shell, defining an accommodating chamber 10 for accommodating the operating member 2 and the cursor control unit 3 and top and bottom openings 11 in communication with the accommodating chamber 10 at the top and bottom sides. The housing 1 has a plurality of bottom mounting hooks 12 for mounting.

The operating member 2 is connected to the cursor control unit 3, having an arched operating top wall 21, a top center recess 22 at the center of the arched operating top wall 21, a flat bottom pressure wall 23, and a bearing surface 24 curved inwards from the center of the flat bottom pressure wall 23 and disposed at an elevation above the flat bottom pressure wall 23.

The cursor control unit 3 is mounted in the accommodating chamber 10 of the housing 1, comprising a shell 31, a plurality of shanks 32, and an elastic member 33. The shell 31 comprises a base 311, an upright support 3112 upwardly extending from top center of the base 311, a plurality of bottom chambers 310 formed in the bottom side of the base 311, a plurality of vertical through holes 3111 respectively upwardly extending from the bottom chambers 310 to top side of the base 311, and a plurality of bottom mounting rods 312. The bottom chambers 310 include one at the center corresponding to the upright support 3112 and the other equiangularly spaced around the center bottom chamber 310. The vertical through holes 3111 are respectively vertically extending from the bottom chambers 310, i.e., the vertical through holes 311 include one vertically extending through the upright support 3112 and the other equiangularly spaced around the upright support 3112. The shanks 32 are respectively mounted in the bottom chambers 310 of the shell 31 and extending through the vertical through holes 3111 over the top side of the base 311. The elastic member 33 comprises a flat base 331 and a plurality of rubber cones 332 at top of the flat base 331 corresponding to the shanks 32 in the bottom chambers 310 of the shell 31. The elastic member 33 is mounted on a substrate 4 to support the shanks 32 on the rubber cones 332. The substrate 4 has a switch structure 5 arranged on top wall thereof.

During installation, the shanks 32 and the rubber cones 332 of the elastic member 33 are respectively inserted into the bottom chambers 310 of the shell 31 in proper order, and then the bottom mounting rods 312 of the shell 31 are respectively fastened to (the respective mounting holes of) the substrate 4, and then the operating member 2 is covered on the cursor control unit 3 with the flat bottom pressure wall 23 and the bearing surface 24 supported on the shanks 32 above the shell 31, and then the housing 1 is covered on the operating member 2 and the cursor control unit 3 to force the bottom mounting hooks 12 into engagement with bottom wall of the substrate 4. When installed, the arched operating top wall 21 of the operating member 2 exposes to out side of the housing 1 through the top opening 11 for operation.

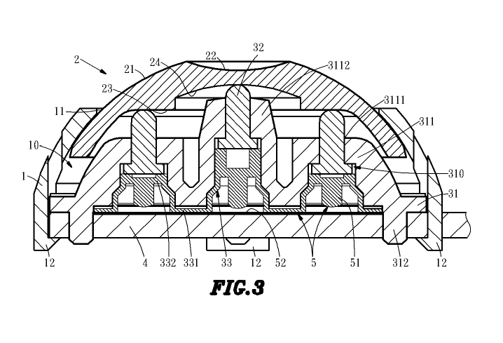

Referring to FIG. 3 again, the rubber cones 332 each have a bottom switch rod 51 for triggering a respective switch 52 to produce a respective output signal for controlling a cursor on a display screen (not shown). The switches 52 and the switch rods 51 form the switch structure 5.

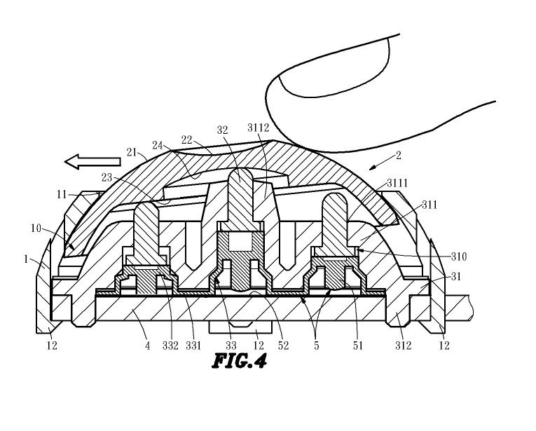

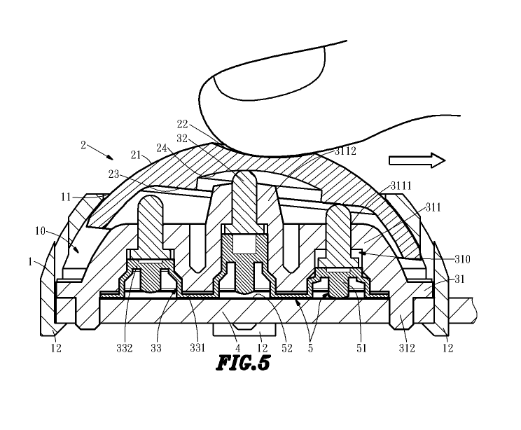

Referring to FIGS. 4 and 5, the bearing surface 24 of the operating member 2 is supported on the shank 32 that passes through the upright support 3112 of the shell 31 and the flat bottom pressure wall 23 of the operating member 2 is supported on the other shanks 32. The user can press one finger on the arched operating top wall 21 of the operating member 2 to move the operating member 2 relative to the cursor control unit 3 in all directions and to further bias the shanks 32 against the respective rubber cones 332, causing the switch structure 5 to produce an output signal indicative of the direction and amount of movement of the operating member 2 relative to the cursor control unit 3. The user can also position the finger in the top center recess 22 and then move the operating member 2 relative to the cursor control unit 3 to control the direction and movement of the cursor on the display screen.

Referring to FIG. 3 again, the substrate 4 according to this embodiment is a circuit board; the switches 52 of the switch structure 5 are membrane switches. When the user moves the operating member 2 to bias one shank 32, the respective rubber cone 332 will be driven to press the respective switch rod 51 on the respective switch 52, causing the respective switch 52 to be deformed subject to the direction and amount of the pressure from the respective switch rod 51. At this time, the respective switch 52 will drive the substrate 4 to produce an output signal indicative of the direction and amount of movement of the operating member 2 relative to the cursor control unit 3.

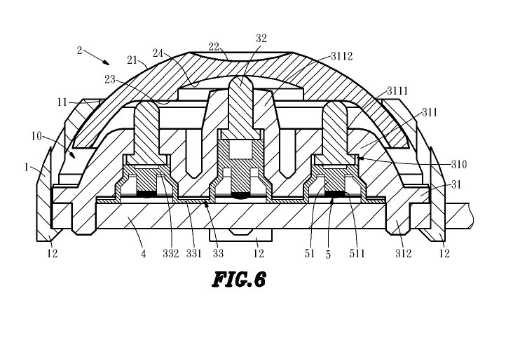

FIG. 6 shows an alternate form of the present invention. According to this embodiment, the aforesaid switches 52 are eliminated, and the switch rod 51 of each rubber cone 332 has the bottom end thereof covered with a layer of carbon coating 511. When the user moves the operating member 2 to bias one shank 32, the respective rubber cone 332 will be driven to press the respective switch rod 51 on the respective contact at the substrate 4, causing the substrate 4 to produce an output signal indicative of the direction and amount of movement of the operating member 2 relative to the cursor control unit 3.

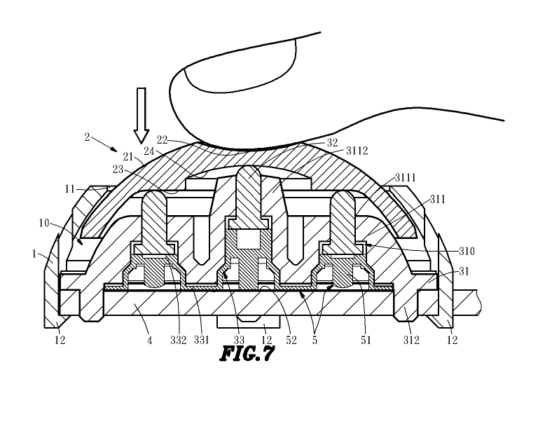

Referring to FIG. 7, the user can rest the finger in the top center recess 22 of the operating member 2 and impart a downward pressure to the shank 32 in the upright support 3112 to further compress the respective rubber cone 332, thereby causing the respective switch rod 51 to trigger the respective switch 52, and therefore the substrate 4 is driven to produce a respective output signal. According to this embodiment, the shank 32 in the upright support 3112 functions like the enter key of a keyboard for triggering the respective switch 52 to produce the output signal of “ENTER”.

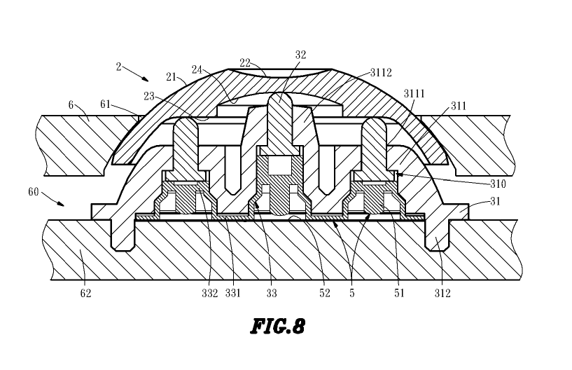

FIG. 8 shows another alternate form of the present invention. According to this embodiment, a housing 6 for electronic apparatus (for example, the housing of a mobile computer, cellular telephone, PDA, model toy vehicle's remote controller, palmtop game machine, satellite navigation system, etc.) is used to substitute for the aforesaid housing 1. The housing 6 has an accommodating chamber 60 and a top through hole 61 in communication with the accommodating chamber 60. The operating member 2 and the cursor control unit 3 are mounted inside the accommodating chamber 60, and the switch structure 5 is provided in between the cursor control unit 3 and a bottom shell 62 of the housing 6. Alternatively, the aforesaid substrate 4 and switch structure 5 can be directly mounted on the bottom shell 62 of the housing 6, achieving the same effects. According to this embodiment, the multi-directional cursor control device is directly mounted inside the mobile electronic apparatus. Alternatively, the multi-directional cursor control device can be provided outside the mobile electronic apparatus, and a wireless communication system is used for transmission of signal from the multi-directional cursor control device to the mobile electronic apparatus. Further, the cursor control unit 3 can be an analog or digital system of mechanical type, resistance type, capacitance type, optical type, switch type or pulse type.

As indicated above, the invention uses a movable operating member 2 having an arched operating top wall 21 and a top center recess 22 for operation by the user to drive a cursor control unit 3 to produce an output signal indicative of the direction and amount of movement of the movable operating member 2, achieving accurate control of the direction and amount of movement of the cursor on the display screen. The design of the present invention has a simple structure that uses a less number of component parts to reduce the manufacturing cost. Further, the design of the present invention greatly reduces the total height of the cursor control device.

A prototype of multi-directional cursor control device has been constructed with the features of FIGS. 1˜8. The multi-directional cursor control device functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A multi-directional cursor control device comprising a housing, a cursor control unit mounted inside said housing, and an operating member for moving by a user to drive said cursor control unit to produce an output signal indicative of the direction and amount of movement of said operating member,
wherein said housing comprises an accommodating chamber that accommodates said cursor control unit and said operating member, and an opening in a top wall thereof in communication with said accommodating chamber; said operating member has an arched operating top wall protruding over said opening of said housing for operation by the user.

2. The multi-directional cursor control device as claimed in claim 1, wherein said housing comprises a plurality of bottom mounting hooks for mounting.

3. The multi-directional cursor control device as claimed in claim 1, wherein said operating member has a top center recess at top center of said arched operating top wall.

4. The multi-directional cursor control device as claimed in claim 1, wherein said operating member has a flat bottom pressure wall, and a bearing surface curved inwards from the center of said flat bottom pressure wall and disposed at an elevation above said flat bottom pressure wall.

5. The multi-directional cursor control device as claimed in claim 1, wherein said cursor control unit comprises:
a shell, said shell comprising a base, said base of said shell having a top side and a bottom side, a plurality of bottom chambers formed in said bottom side of said base, a plurality of vertical through holes respectively upwardly extending from said bottom chambers to said top side of said base;
a plurality of shanks respectively mounted in said bottom chambers of said shell and extending through said vertical through holes over said top side of said base;
an elastic member, said elastic member comprising a flat base and a plurality of rubber cones at a top of said flat base of said elastic member corresponding to said shanks;
a substrate; and
a switch structure provided at said substrate for triggering by said shanks through said rubber cones to product an output signal indicative of the direction and amount of movement of said operating member relative to said cursor control unit.

6. The multi-directional cursor control device as claimed in claim 5, wherein said shell of said cursor control unit further comprises an upright support upwardly extending from said base thereof at the center; said bottom chamber of said shell include a center bottom chamber disposed at a bottom side of said upright support; said vertical through hole of said shell includes a vertical center through hole upwardly extending from said center bottom chamber through top and bottom ends of said upright support.

7. The multi-directional cursor control device as claimed in claim 5, wherein said shell comprises a plurality of bottom mounting rods for mounting.

8. The multi-directional cursor control device as claimed in claim 5, wherein said rubber cones include a center rubber cone at center of said flat base of said elastic member, and a plurality of border rubber cones equiangularly spaced around said center rubber cone.

9. The multi-directional cursor control device as claimed in claim 5, wherein said switch structure comprises a plurality of switch robs respectively vertically formed integral with a bottom side of each of said rubber cones, and a plurality of switches respectively provided at said substrate corresponding to said switch rods.

10. The multi-directional cursor control device as claimed in claim 9, wherein said switch rods each have a bottom side covered with a layer of carbon coating.

11. The multi-directional cursor control device as claimed in claim 9, wherein said switches are membrane switches.

12. The multi-directional cursor control device as claimed in claim 5, wherein said substrate is a circuit board.

13. The multi-directional cursor control device as claimed in claim 5, wherein said housing is the housing of an electronic apparatus.
